(19) United States
(12) Patent Application Publication
(10) Pub. No.: US 2012/0062512 A1
(43) Pub. Date: Mar. 15, 2012

(54) DRIVING METHOD AND APPARATUS OF TOUCH PANEL

(75) Inventors: CHIEN-YUNG CHENG, Miao-Li County (TW); PO-SHENG SHIH, Miao-Li County (TW); PO-YANG CHEN, Miao-Li County (TW)

(73) Assignee: CHIMEI INNOLUX CORPORATION, Miao-Li County (TW)

(21) Appl. No.: 13/227,602

(22) Filed: Sep. 8, 2011

(30) Foreign Application Priority Data
Sep. 9, 2010 (CN) 201010277282.1

(51) Int. Cl. G06F 3/045

(52) U.S. Cl. 345/174

(57) ABSTRACT

A driving method and apparatus of a touch panel are provided. The touch panel includes a conductive layer with anisotropic conductivity. The method includes the following steps. An electrode pair is selected one by one in a plurality of electrode pairs. Each of the electrode pairs includes a first electrode and a second electrode. The first electrodes are disposed on a first side of the conductive layer, and the second electrodes are disposed on a second side of the conductive layer. When an electrode pair of the electrode pairs is selected, the first electrode and the second electrode of the selected electrode pair are driven one by one.

### BACKGROUND OF THE DISCLOSURE

1. Field of the Disclosure

The present disclosure generally relates to a touch panel, in particular, to a driving method and apparatus of a touch panel.

2. Description of Related Art

To achieve the higher portability, smaller volume and more humane design, lots of information products adopt an input method of a touch panel to replace the conventional keyboard and mouse. The touch panel may be assembled on many sorts of flat panel displays and provide the flat panel display with both the image display and operation information input functions. The conventional touch panel mainly includes resistive, capacitive, infrared and surface acoustic wave types. Different types of touch panels have varying benefits and drawbacks, for example, the capacitive touch panel exhibits vivid images and only needs a small touch force but the price is quite high. Therefore, it has always been a subject in this field to reduce the cost of the touch panel and accurately position a touch point (TP).

### SUMMARY OF THE DISCLOSURE

Accordingly, the present disclosure is directed to a driving method and apparatus of a touch panel, so as to implement a function of accurately positioning a TP of the touch panel.

In an embodiment of the present disclosure, a driving method of a touch panel is provided. The touch panel includes a conductive layer with anisotropic conductivity in a first axial direction, and two opposite sides of the conductive layer along the first axial direction are respectively a first side and a second side. The conductive layer includes a plurality of electrode pairs, and each of the electrode pairs includes a first electrode and a second electrode. The first electrodes are disposed on the first side of the conductive layer, and the second electrodes are disposed on the second side of the conductive layer. The method includes: selecting an electrode pair one by one in the plurality of electrode pairs; and when an electrode pair of the electrode pairs is selected, driving the first electrode and the second electrode of the selected electrode pair one by one.

In an embodiment of the present disclosure, a driving apparatus of a touch panel is provided. The touch panel includes a conductive layer with anisotropic conductivity in a first axial direction, and two opposite sides of the conductive layer along the first axial direction are respectively a first side and a second side. The driving apparatus includes a plurality of electrode pairs, a selector and a sensing circuit. Each of the electrode pairs includes a first electrode and a second electrode. The first electrodes are disposed on the first side of the conductive layer. The second electrodes are disposed on the second side of the conductive layer. The selector is connected to the electrode pairs of the conductive layer. The selector selects an electrode pair one by one in the electrode pairs. The sensing circuit is connected to the selector. When an electrode pair of the electrode pairs is selected, the sensing circuit drives the first electrode and the second electrode of the selected electrode pair one by one through the selector.

In an embodiment of the present disclosure, a reference voltage is provided to the first electrodes and the second electrodes of other electrode pairs besides the selected electrode pair.

In an embodiment of the present disclosure, electrode pairs adjacent to the selected electrode pair are floating, and a reference voltage is provided to the first electrodes and the second electrodes of other electrode pairs besides the selected electrode pair and the electrode pairs adjacent to the selected electrode pair.

In an embodiment of the present disclosure, when one of the first electrode and the second electrode of the selected electrode pair is driven, the other of the first electrode and the second electrode is floating or provided with the reference voltage.

In an embodiment of the present disclosure, the step of driving the first electrode and the second electrode of the selected electrode pair one by one includes: providing a driving voltage to the first electrode of the selected electrode pair; after the driving voltage is removed from the first electrode of the selected electrode pair, sensing the first electrode of the selected electrode pair; after the sensing of the first electrode of the selected electrode pair is finished, providing the driving voltage to the second electrode of the selected electrode pair; and after the driving voltage is removed from the second electrode of the selected electrode pair, sensing the second electrode of the selected electrode pair.

In order to make the aforementioned features and advantages of the present disclosure comprehensible, embodiments are described in detail below with reference to the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic view illustrating a capacitive touch panel and a driving apparatus according to an embodiment of the present disclosure.

FIG. 1B is a schematic partial cross-sectional view of the touch panel in FIG. 1A taken along a section line A-A′.

FIG. 2A is a schematic view illustrating sensing values of second electrodes S21 to S26 in FIG. 1A according to an embodiment of the present disclosure.

FIG. 2B is a schematic view illustrating sensing values of first electrodes S11 to S16 in FIG. 1A according to an embodiment of the present disclosure.

FIG. 2C is a schematic view illustrating adding the sensing value of each of the first electrodes S11 to S16 and the sensing value of the corresponding one of the second electrodes S21 to S26 in FIG. 1A according to an embodiment of the present disclosure.

FIG. 3 illustrates a situation that a TP moves according to an embodiment.

FIG. 4 illustrates a driving method of a touch panel according to another embodiment of the present disclosure.

FIG. 5 is a schematic view illustrating a driving sequence of electrodes of the touch panel shown in FIG. 1A.

FIG. 6 is a schematic view illustrating a driving sequence of electrodes of the touch panel shown in FIG. 1A according to another embodiment.

### DESCRIPTION OF EMBODIMENTS

Reference will now be made in detail to the present embodiments of the disclosure, examples of which are illustrated in the accompanying drawings. Wherever possible, the same reference numbers are used in the drawings and the description to refer to the same or like parts.

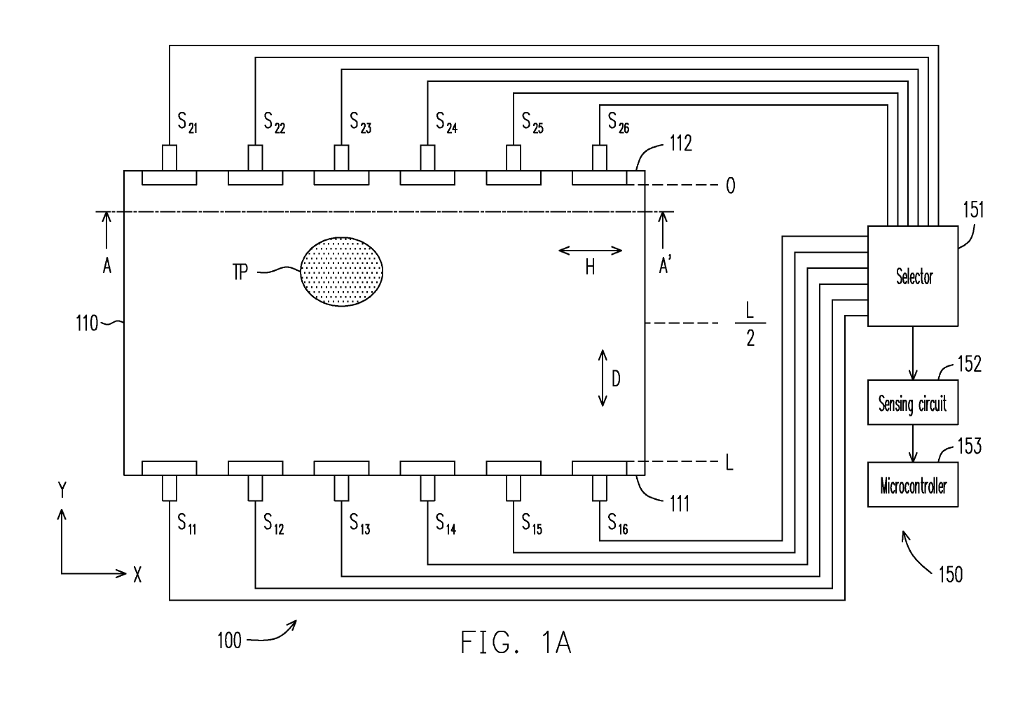

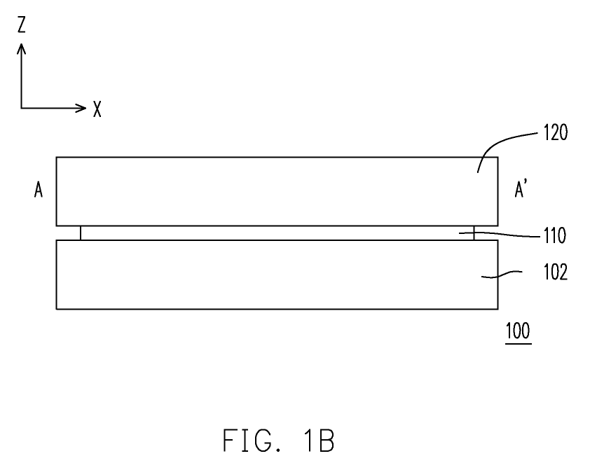

FIG. 1A is a schematic view illustrating a capacitive touch panel 100 and a driving apparatus 150 according to an embodiment of the present disclosure. FIG. 1B is a schematic partial cross-sectional view of the touch panel 100 in FIG. 1A taken along a section line A-A′. A Cartesian coordinate system is introduced in FIG. 1A and FIG. 1B, which includes an X-axis direction, a Y-axis direction and a Z-axis direction perpendicular to one other. The touch panel 100 includes a conductive layer 110, a cover lens 120 and a substrate 102. The conductive layer 110 is disposed on the substrate 102, and the cover lens 120 is disposed on the conductive layer 110. The conductive layer 110 has anisotropic conductivity, that is, the conductive film 110 has different impedance properties in two different directions. For example, the conductive layer 110 has a low impedance direction D and a high impedance direction H shown in FIG. 1A, in which the low impedance direction D and the high impedance direction H may be perpendicular. In this embodiment, the low impedance direction D of the conductive layer 110 is the Y-axis direction.

In this embodiment, the substrate 102 and/or the cover lens 120 may be made of a transparent material such as polyethylene (PE), polycarbonate (PC), polyethylene Terephthalate (PET), polymethyl methacrylate (PMMA) or a thinned glass substrate. The conductive layer 110 may be a conductive film formed by carbon nano-tubes (CNTs) arranged in parallel. The CNT film is made by stretching a super vertical-aligned carbon nanotube array and is applicable to fabricating transparent conductive films. For example, a CNT layer is formed on a silicon substrate, a quartz substrate or other suitable substrates by chemical vapor deposition (CVD) or other suitable methods. Then, a CNT film, i.e., the conductive layer 110, is stretched out from one side of the CNT layer along a stretching direction. Afterwards, the conductive layer 110 is disposed on the substrate 102 and meanwhile, the cover lens 120 is covered on the conductive layer 110, thus preliminarily finishing the capacitive touch panel 100. As the long chain CNTs are approximately arranged in parallel along the stretching direction in the stretching process, the CNT film has a low impedance in the stretching direction, and an impedance in a direction perpendicular to the stretching direction is about 50 to 350 times of the impedance in the stretching direction. A surface resistance of the CNT film ranges from 1 KΩ to 800 KΩ due to different measurement positions and directions. Therefore, the conductive layer 110 has anisotropic conductivity.

Referring to FIG. 1A, two opposite sides of the conductive layer 110 along a first axial direction (for example, the Y-axis direction) are respectively a first side 111 and a second side 112. A plurality of electrode pairs is disposed on the conductive layer 110, and each of the electrode pairs includes a first electrode and a second electrode. The first electrode and the second electrode of each electrode pair are respectively disposed on two opposite sides 111 and 112 of the conductive layer. In this embodiment, a connection line direction from the first electrode to the second electrode of each electrode pair is the same as the first axial direction (i.e., the low impedance direction D), that is, the first electrode and the second electrode are located in the first axial direction (i.e., the low impedance direction D). For example, a first electrode pair is a first electrode S11 and a second electrode S21; a second electrode pair is a first electrode S12 and a second electrode S22; a third electrode pair is a first electrode S13 and a second electrode S23; a fourth electrode pair is a first electrode S14 and a second electrode S24; a fifth electrode pair is a first electrode S15 and a second electrode S25; and a sixth electrode pair is a first electrode S16 and a second electrode S26. The first electrodes S11 to S16 of the electrode pairs are disposed on the first side 111 of the conductive layer 110. The second electrodes S21 to S26 of the electrode pairs are disposed on the second side 112 of the conductive layer 110.

It is taken as an implementation example that six electrode pairs are disposed on the capacitive touch panel 100 in FIG. 1A. However, in practical applications, the number of the electrode pairs may be determined according to the actual area and design requirements of the touch panel.

For simplicity, only one TP is illustrated when the touch panel 100 is operated in the following embodiments. In practical operations, the positioning method of this embodiment is also applicable to multiple TPs.

Referring to FIG. 1A, the driving apparatus 150 includes a selector 151 and a sensing circuit 152. In this embodiment, the first electrodes S11 to S16 and the second electrodes S21 to S26 are scanned and driven along the X-axis direction. For example, the scanning and driving sequence may be S11, S12, S13, S14, S15, S16, S26, S25, S24, S23, S22, S21; or the driving sequence may be S11, S12, S13, S14, S15, S16, S21, S22, S23, S24, S25, S26. The selector 151 is connected to the electrodes S11 to S16 and S21 to S26 of the conductive layer 110. The selector 151 selects an electrode one by one according to the abovementioned sequence, and provides a reference voltage (for example, a grounding voltage or other fixed level reference voltages) to other electrodes that are not selected. The sensing circuit 152 is connected between the selector 151 and a microcontroller 153. When an electrode pair of the electrodes S11 to S16 and S21 to S26 is selected, the sensing circuit 152 drives the selected electrode through the selector 151. The driving operation includes, for example, applying a driving voltage to the selected electrode to charge the conductive layer 110, then sensing a physical characteristic value (i.e., a sensing value such as a voltage value, quantity of electric charge or a capacitance value) of the selected electrode, and transferring the sensing value of the driven electrode to the microcontroller 153. The microcontroller 153 may calculate X-axis and Y-axis positions according to the sensing values of the first electrodes S11 to S16 and the sensing values of the second electrodes S21 to S26.

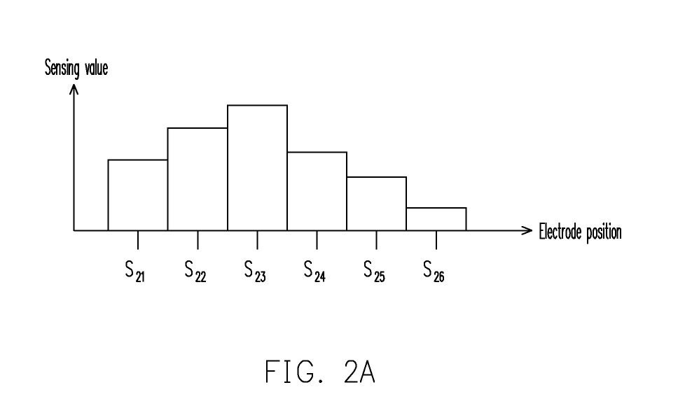

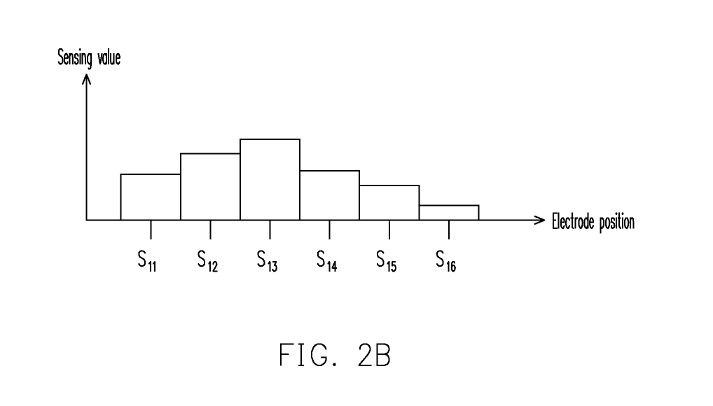

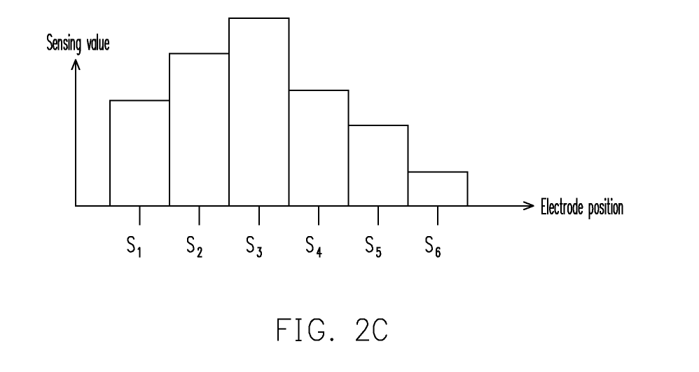

When a finger touches the touch panel 100 (i.e., the TP shown in FIG. 1A), a plurality of sensing values is obtained after sensing the first electrodes S11 to S16 and the second electrodes S21 to S26. FIG. 2A is a schematic view illustrating the sensing values of the second electrodes S21 to S26 in FIG. 1A according to an embodiment of the present disclosure. The horizontal axis represents positions of the second electrodes S21 to S26, and the vertical axis represents the sensing values. As the TP is close to the second electrode S23, a relative extreme occurs at S23 in FIG. 2A, for example, the sensing value of the second electrode S23 is greater besides the sensing values of the adjacent second electrodes. Similarly, FIG. 2B is a schematic view illustrating the sensing values of the first electrodes S11 to S16 in FIG. 1A according to an embodiment of the present disclosure. The horizontal axis represents positions of the first electrodes S11 to S16, and the vertical axis represents the sensing values. A relative extreme also occurs at S13 in FIG. 2B. As the distance between the TP and the first electrodes S11 to S16 is greater besides the distance between the TP and the second electrodes S21 to S26, the sensing values of the first electrodes S11 to S16 are smaller besides the sensing values of the second electrodes S21 to S26 on the whole.

In this embodiment, the microcontroller 153 adds the sensing value of each of the first electrodes S11 to S16 and the sensing value of the corresponding one of the second electrodes S21 to S26 to obtain sensing values of electrode pairs S1, S2, S3, S4, S5 and S6. For example, S1=S11+S21, S2=S12+S22, and so forth. FIG. 2C is a schematic view illustrating adding the sensing value of each of the first electrodes S11 to S16 and the sensing value of the corresponding one of the second electrodes S21 to S26 in FIG. 1A according to an embodiment of the present disclosure. The horizontal axis represents positions of the electrodes (for example, an X-axis position), and the vertical axis represents the sensing values. Then, the position of the relative extreme of the electrode pairs S1 to S6 (herein, the position of the electrode pair S3) is used as the position of the TP on the touch panel 100 in a second axial direction (for example, the X-axis direction).

In other embodiments, the position of the TP in the X axis may be decided by the position where the relative extreme occurs in the first electrodes S11 to S16 (herein, the position of the first electrode S13), or decided by the position where the relative extreme occurs in the second electrodes S21 to S26 (herein, the position of the second electrode S23). In the application of this embodiment, interpolation or other algorithms may also be adopted to calculate a more accurate position in the second axial direction according to the design requirements.

When the microcontroller 153 finds that the relative extreme occurs at the first electrode S13, the microcontroller 153 calculates a position in the first axial direction (for example, the Y axis) according to the sensing values of the first electrode S13 and the second electrode S23 in the same electrode pair. According to a ratio between the sensing values of the first electrode S13 and the second electrode S23, the microcontroller 153 can calculate the position of the TP in the Y axis. For example, if the sensing value of the first electrode S13 is equal to the sensing value of the second electrode S23, it indicates that the TP is located at the (L/2) position of the Y axis.

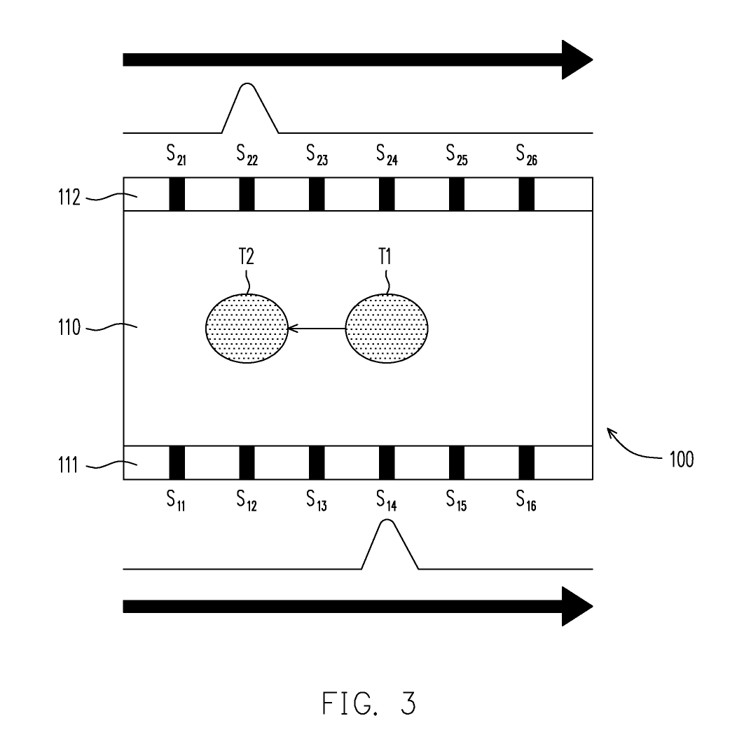

FIG. 3 illustrates a situation that a TP moves according to an embodiment. The selector 151 selects/scans each electrode in a sequence of S11, S12, S13, S14, S15, S16, S21, S22, S23, S24, S25, S26. It is assumed that a position of the TP before moving is T1 shown in FIG. 3. After a driving operation of the first electrodes S11 to S16 is finished, the microcontroller 153 may find a relative extreme at the first electrode S14, which indicates that an X-axis position of the TP is near the first electrode S14. Therefore, after a driving operation of the second electrodes S21 to S26 is finished, the microcontroller 153 calculates a Y-axis position of the TP according to a ratio between sensing values of the first electrode S14 and the second electrode S24. As after the electrode S14 is driven, the electrodes S14, S15, S16, S21, S22 and S23 still need to be driven in sequence before the electrode S24 is driven, a time difference exists between a time point of driving the first electrode S14 and a time point of driving the second electrode S24. It is assumed that the number of electrodes on one side is N, and the time for driving one electrode is t; then the time difference is about N×t. However, during the time difference N×t, the TP moves from T1 to T2 shown in FIG. 3 along the X axis. Due to the moving of the TP, the relative extreme which should have occurred at the second electrode S24 mistakenly occurs at the second electrode S22. It is imaginable that, as shown in FIG. 3, the Y-axis position calculated by the microcontroller 153 according to the sensing values of the first electrode S14 and the second electrode S24 is definitely wrong.

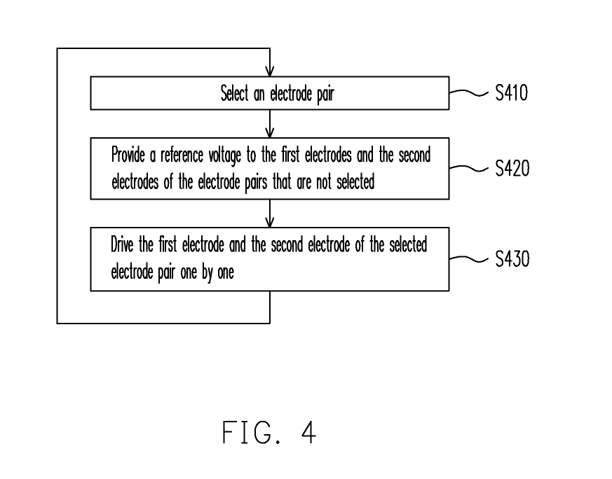

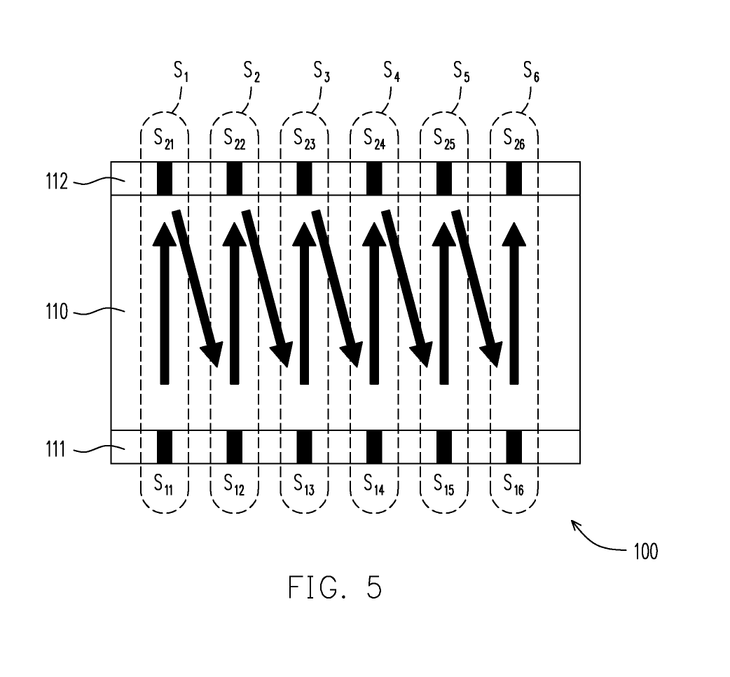

FIG. 4 illustrates a driving method of the touch panel 100 according to another embodiment of the present disclosure. FIG. 5 is a schematic view illustrating a driving sequence of electrodes of the touch panel 100 shown in FIG. 1A. An electrode pair S1 is a first electrode S11 and a second electrode S21; an electrode pair S2 is a first electrode S12 and a second electrode S22; an electrode pair S3 is a first electrode S13 and a second electrode S23; an electrode pair S4 is a first electrode S14 and a second electrode S24; an electrode pair S5 is a first electrode S15 and a second electrode S25; and an electrode pair S6 is a first electrode S16 and a second electrode S26. The first electrodes S11 to S16 of the electrode pairs are disposed on a first side 111 of a conductive layer 110. The second electrodes S21 to S26 of the electrode pairs are disposed on a second side 112 of the conductive layer 110. In each of the electrode pairs S1 to S6, a direction from the first electrode to the second electrode is a first axial direction (or a low impedance direction D).

Referring to FIG. 1A, FIG. 4 and FIG. 5, in step S410, a selector 151 selects an electrode pair one by one in a plurality of electrode pairs S1 to S6. In an embodiment shown in FIG. 5, a selection sequence of the electrode pairs S1 to S6 is, for example, S1, S2, S3, S4, S5, S6. In other embodiments, the selection sequence of the electrode pairs S1 to S6 may be other sequences, for example, a random sequence, which is not limited herein.

When an electrode pair of the electrode pairs S1 to S6 is selected in step S410, the selector 151 performs step S420 to provide a reference voltage (for example, a grounding voltage or other fixed level reference voltages) to other first electrodes and second electrodes that are not selected. For example, if the selector 151 selects the electrode pair S2 in step S410, the selector 151 provides a grounding voltage to the other electrode pairs S1 and S3 to S6 that are not selected in step S420.

When an electrode pair of the electrode pairs S1 to S6 is selected in step S410, a sensing circuit 152 performs step S430 to drive the first electrode and the second electrode of the selected electrode pair one by one through the selector 151. In this embodiment, when the sensing circuit 152 drives one of the first electrode and the second electrode of the selected electrode pair, the other of the first electrode and second electrode is floating. In other embodiments, when the sensing circuit 152 drives one of the first electrode and the second electrode of the selected electrode pair, the selector 151 provides a reference voltage (for example, a grounding voltage) to the other of the first electrode and the second electrode. For example, if the electrode pair S2 is selected in step S410, the sensing circuit 152 may first drive the first electrode S12 through the selector 151, and at the same time the selector 151 makes the second electrode S22 floating. After a driving operation on the first electrode S12 is finished, the sensing circuit 152 then drives the second electrode S22 through the selector 151, and at the same time the selector 151 makes the first electrode S12 floating. The driving sequence of the electrodes of the touch panel 100 in this embodiment is shown in FIG. 5.

The driving operation of one electrode pair (i.e., step S430) is described as follows. The sensing circuit 152 provides a driving voltage (for example, a power supply voltage VDD) to the first electrode of the selected electrode pair. After the driving voltage is removed from the first electrode of the selected electrode pair, the sensing circuit 152 senses the first electrode of the selected electrode pair. After finishing sensing the first electrode of the selected electrode pair, the sensing circuit 152 provides the driving voltage to the second electrode of the selected electrode pair. After the driving voltage is removed from the second electrode of the selected electrode pair, the sensing circuit 152 senses the second electrode of the selected electrode pair.

It is assumed that a TP is near the second electrode S23. A small time difference exists between a time point of driving the first electrode S13 and a time point of driving the second electrode S23 in the embodiment shown in FIG. 5. The time difference is about 1×t. Compared with the time difference N×t of the embodiment shown in FIG. 3, the time difference 1×t of the embodiment shown in FIG. 5 is obviously much smaller, and therefore has higher accuracy. Especially when the number of the electrodes N on one side of the touch panel 100 is greater, the effect of improving the driving time difference of the electrode pair is better.

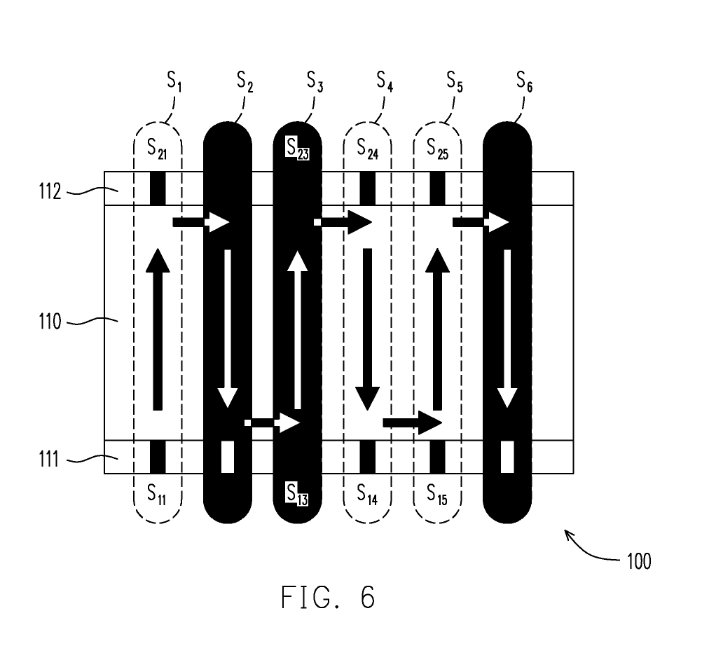

For the selected electrode pair, the driving sequence of the first electrode and the second electrode may be “the first electrode, the second electrode” (as shown in FIG. 5), or other sequences such as a random sequence, which is not limited herein. For example, FIG. 6 is a schematic view illustrating a driving sequence of electrodes of the touch panel 100 shown in FIG. 1A according to another embodiment. In the embodiment shown in FIG. 6, for the selected electrode pair, the driving sequence of the first electrode and the second electrode may be two sequences of “the first electrode, the second electrode” and “the second electrode, the first electrode” in the alternative. For other implementation manners of FIG. 6, reference may be made to related descriptions of FIG. 4 and FIG. 5.

The above embodiments teach that, when the selected electrode pair is driven, a reference voltage (for example, a grounding voltage) is provided to other electrode pairs. However, implementation manners of the present disclosure are not limited to this. In other embodiments, when an electrode pair of a plurality of electrode pairs is selected, the selector 151 may make electrode pairs adjacent to the selected electrode pair floating, and then provide a reference voltage to other electrode pairs besides the selected electrode pair and the electrode pairs adjacent to the selected electrode pair. For example, when the electrode pair S3 is selected, the selector 151 may make the electrode pairs S2 and S4 adjacent to the electrode pair S3 floating, and then provide a reference voltage to the first electrodes and the second electrodes of the other electrode pairs S1, S5 and S6.

For another example, when the electrode pair S3 is selected, the selector 151 may make the electrode pairs S1, S2, S4 and S5 adjacent to the electrode pair S3 floating, and then provide a reference voltage to the first electrode and the second electrode of the other electrode pair S6. The number of the floating electrode pairs may be decided according to design requirements.

Further, according to the design requirements, both the first electrode and the second electrode of the electrode pair adjacent to the selected electrode pair may be floating, or one of the electrodes is floating and the other is provided with a reference voltage. For example, it is assumed that the electrode pair S3 is selected. When the first electrode S13 is driven, the selector 151 may make the first electrodes S12 and S14 of the electrode pairs S2 and S4 floating, and provide a reference voltage to the second electrodes S22 and S24. When the second electrode S23 is driven, the selector 151 may make the second electrodes S22 and S24 of the electrode pairs S2 and S4 floating, and provide a reference voltage to the first electrodes S12 and S14.

In another embodiment, it is assumed that the electrode pair S3 is selected. When the first electrode S13 is driven, the selector 151 may make the second electrodes S22 and S24 of the electrode pairs S2 and S4 floating, and provide a reference voltage to the first electrodes S12 and S14. When the second electrode S23 is driven, the selector 151 may make the first electrodes S12 and S14 of the electrode pairs S2 and S4 floating, and provide a reference voltage to the second electrodes S22 and S24.

In conclusion, in the above embodiments, a plurality of electrode pairs S1 to S6 is disposed on the conductive layer 110 with anisotropic conductivity, and the first electrode and the second electrode of each electrode pair are respectively disposed on the two opposite sides 111 and 112 of the conductive layer 110. A position in the first axial direction (for example, the Y axis) may be calculated according to two sensing values of the electrode pair. As the driving operation on one electrode pair is finished before the driving operation on the next electrode pair is performed, the present disclosure has high accuracy and can implement a touch gesture function.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A driving method of a touch panel, wherein the touch panel comprises a conductive layer with anisotropic conductivity in a first axial direction, two opposite sides of the conductive layer along the first axial direction are respectively a first side and a second side, the conductive layer comprises a plurality of electrode pairs, each of the electrode pairs comprises a first electrode and a second electrode, the first electrodes are disposed on the first side of the conductive layer, and the second electrodes are disposed on the second side of the conductive layer, the driving method comprising:
selecting an electrode pair one by one in the electrode pairs; and
when an electrode pair of the electrode pairs is selected, driving the first electrode and the second electrode of the selected electrode pair one by one.

2. The driving method of a touch panel according to claim 1, further comprising:
providing a reference voltage to the first electrodes and the second electrodes of other electrode pairs besides the selected electrode pair.

3. The driving method of a touch panel according to claim 1, further comprising:
floating the electrode pairs adjacent to the selected electrode pair; and
providing a reference voltage to the first electrodes and the second electrodes of other electrode pairs besides the selected electrode pair and the electrode pairs adjacent to the selected electrode pair.

4. The driving method of a touch panel according to claim 3, wherein the reference voltage is a grounding voltage.

5. The driving method of a touch panel according to claim 1, wherein when one of the first electrode and the second electrode of the selected electrode pair is driven, the other of the first electrode and the second electrode is provided with a reference voltage.

6. The driving method of a touch panel according to claim 1, wherein when one of the first electrode and the second electrode of the selected electrode pair is driven, the other of the first electrode and the second electrode is floating.

7. The driving method of a touch panel according to claim 1, wherein the step of driving the first electrode and the second electrode of the selected electrode pair one by one comprises:
providing a driving voltage to the first electrode of the selected electrode pair;
after the driving voltage is removed from the first electrode of the selected electrode pair, sensing the first electrode of the selected electrode pair;
after the sensing of the first electrode of the selected electrode pair is finished, providing the driving voltage to the second electrode of the selected electrode pair; and
after the driving voltage is removed from the second electrode of the selected electrode pair, sensing the second electrode of the selected electrode pair.

8. The driving method of a touch panel according to claim 1, wherein a low impedance direction of the conductive layer is the first axial direction.

9. The driving method of a touch panel according to claim 1, wherein the conductive layer is a carbon nano-tube (CNT) film.

10. The driving method of a touch panel according to claim 1, wherein in the electrode pairs, a direction from the first electrodes to the second electrodes is the first axial direction.

11. A driving apparatus of a touch panel, wherein the touch panel comprises a conductive layer with anisotropic conductivity in a first axial direction, and two opposite sides of the conductive layer along the first axial direction are respectively a first side and a second side, the driving apparatus comprising:
a plurality of electrode pairs, wherein each of the electrode pairs comprises a first electrode and a second electrode, the first electrodes are disposed on the first side of the conductive layer, and the second electrodes are disposed on the second side of the conductive layer;
a selector, wherein the selector is connected to the electrode pairs of the conductive layer, and selects an electrode pair one by one in the electrode pairs; and
a sensing circuit, connected to the selector, wherein when an electrode pair of the electrode pairs is selected, the sensing circuit drives the first electrode and the second electrode of the selected electrode pair one by one through the selector.

12. The driving apparatus of a touch panel according to claim 11, wherein the selector provides a reference voltage to other electrode pairs besides the selected electrode pair.

13. The driving apparatus of a touch panel according to claim 11, wherein the selector makes electrode pairs adjacent to the selected electrode pair floating, and provides a reference voltage to other electrode pairs besides the selected electrode pair and the electrode pairs adjacent to the selected electrode pair.

14. The driving apparatus of a touch panel according to claim 13, wherein the reference voltage is a grounding voltage.

15. The driving apparatus of a touch panel according to claim 11, wherein when the sensing circuit drives one of the first electrode and the second electrode of the selected electrode pair, the other of the first electrode and the second electrode is provided with a reference voltage.

16. The driving apparatus of a touch panel according to claim 11, wherein when the sensing circuit drives one of the first electrode and the second electrode of the selected electrode pair, the other of the first electrode and the second electrode is floating.

17. The driving apparatus of a touch panel according to claim 11, wherein the sensing circuit provides a driving voltage to the first electrode of the selected electrode pair; after the driving voltage is removed from the first electrode of the selected electrode pair, the sensing circuit senses the first electrode of the selected electrode pair; after finishing sensing the first electrode of the selected electrode pair, the sensing circuit provides the driving voltage to the second electrode of the selected electrode pair; and after the driving voltage is removed from the second electrode of the selected electrode pair, the sensing circuit senses the second electrode of the selected electrode pair.

18. The driving apparatus of a touch panel according to claim 11, wherein a low impedance direction of the conductive layer is the first axial direction.

19. The driving apparatus of a touch panel according to claim 11, wherein the conductive layer is a carbon nano-tube (CNT) film.

20. The driving apparatus of a touch panel according to claim 11, wherein in the electrode pairs, a direction from the first electrodes to the second electrodes is the first axial direction.
